(19) United States
(12) Patent Application Publication
(10) Pub. No.: US 2005/0273187 A1
(43) Pub. Date: Dec. 8, 2005

(54) Multi-sound source wireless transmission system

(76) Inventor: Tseng-Tien Peng, Taipei Hsien (TW)

Correspondence Address: TSENG-TIEN PENG, 235 Chung-Ho, P.O. BOX 10-69, Taipei, TW

(21) Appl. No.: 10/862,175

(22) Filed: Jun. 7, 2004

(51) Int. Cl. G06F 17/00; H04B 5/00

(52) U.S. Cl. 700/94; 381/79

(57) ABSTRACT

A multi-sound source wireless transmission system comprises a USB connector capable of being inserted to one of a notebook computer or an audio signal wire connected to a first electronic device; a transmission module connected to the USB connector for wirelessly transmitting sound signals to a receiving module in another far end second electronic device. The second electronic device is one of a CDs, MP3 players, TVs, Tuners, DVDs, VCDs, stereos, and computers. The wireless transmission is one of RF transmission and blue tooth transmission. The second electronic device is a head mounted earphone. The receiving module is capable of being hung on the waist and is connected to an inserting type earphone. The receiving module is installed to an MP3 player; and the receiving module is connected to an inserting type earphone for listening the sounds from the earphone.

### FIELD OF THE INVENTION

The present invention relates to wireless transmission of sound signals, and particular to a multi-sound source wireless transmission system which can transmit signal easily and clearly.

### BACKGROUND OF THE INVENTION

Conventionally, the sounds of electronic products, such as CDs, MP3 players, TVs, Tuners, DVDs, VCDs, stereos, etc., are outputted through sound wires to trumpets, or earphones so that listeners can hear the sounds. However, above mentioned prior arts have the following defects.

In general, the electronic products have no wireless transmission functions. They transfer signals by wired ways. Thereby, the user cannot hear the sound in far ends with a preferred sound quality.

Since the transmission is by wired way, the transmission distance is limited. If the transmission distance is too long, decay will generate so as to destroy the sound quality.

Moreover, the wire transmission will induce long assembly time and complicated assembly process.

### SUMMARY OF THE INVENTION

Accordingly, the primary of the present invention is to provide a multi-sound source wireless transmission system, wherein the sound signal is transmitted by a receiving module wirelessly so that the sound signal can be transmitted to a receiving module at a far end.

Another object of the present invention is to provide a multi-sound source wireless transmission system, wherein the user can have a preferred sound quality without decay of signals.

Another object of the present invention is to provide a multi-sound source wireless transmission system, wherein the present invention can be assembled quickly and easily.

To achieve above object, the present invention provides a multi-sound source wireless transmission system. The system comprises a USB connector capable of being inserted to one of a notebook computer or an audio signal wire connected to a first electronic device; a transmission module connected to the USB connector; for wirelessly transmitting sound signals to a receiving module in another far end second electronic device. The second electronic device is one of a CDs, MP3 players, TVs, Tuners, DVDs, VCDs, stereos, and computers. The wireless transmission is one of RF transmission and blue tooth transmission. The second electronic device is a head mounted earphone. The receiving module is hung on the waist and is connected to an inserting type earphone. The receiving module is installed to an MP3 player for hanging from the neck of the user; and the receiving module is connected to an inserting type earphone for listening the sounds from the earphone.

The various objects and advantages of the present invention will be more readily understood from the following detailed description when read in conjunction with the appended drawing.

### BRIEF DESCRIPTION OF THE DRAWINGS

FIGS. 1A to 1C shows the first embodiment of the multi-sound source wireless transmission system of the present invention.

FIGS. 2A to 2C shows the second embodiment of the multi-sound source wireless transmission system of the present invention.

FIG. 3A to 3C shows the third embodiment of the multi-sound source wireless transmission system of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

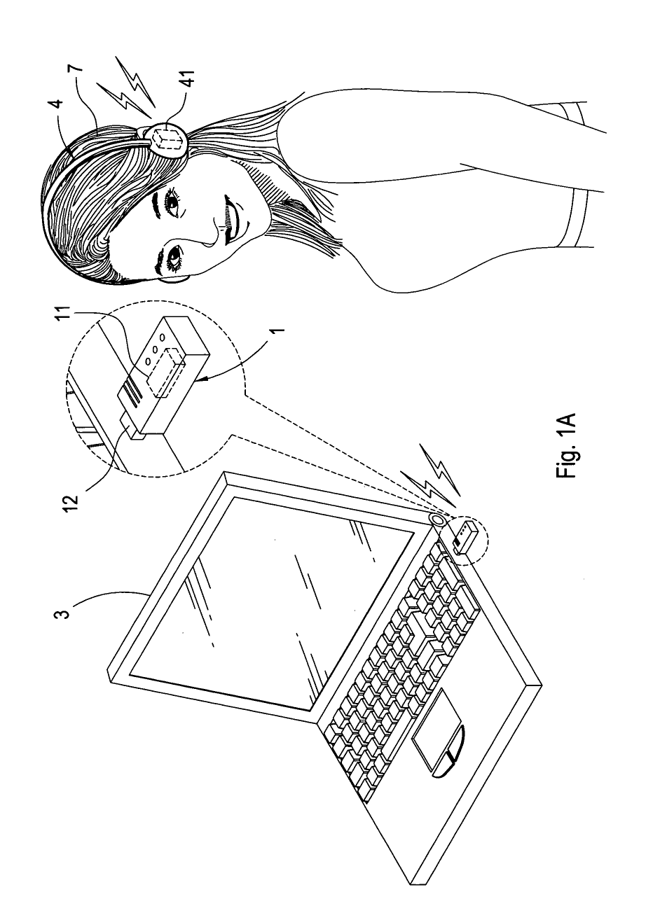

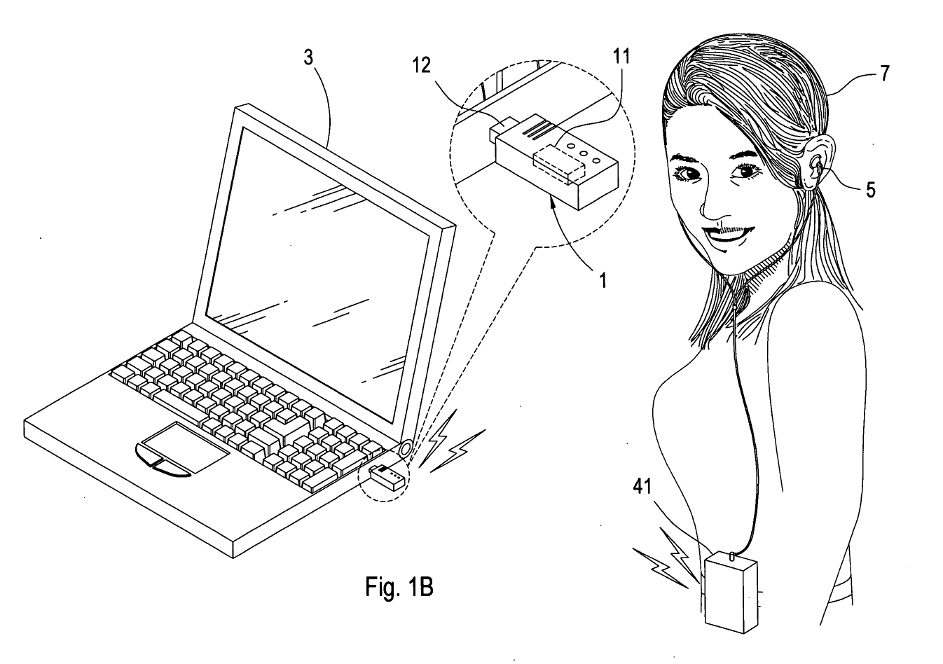

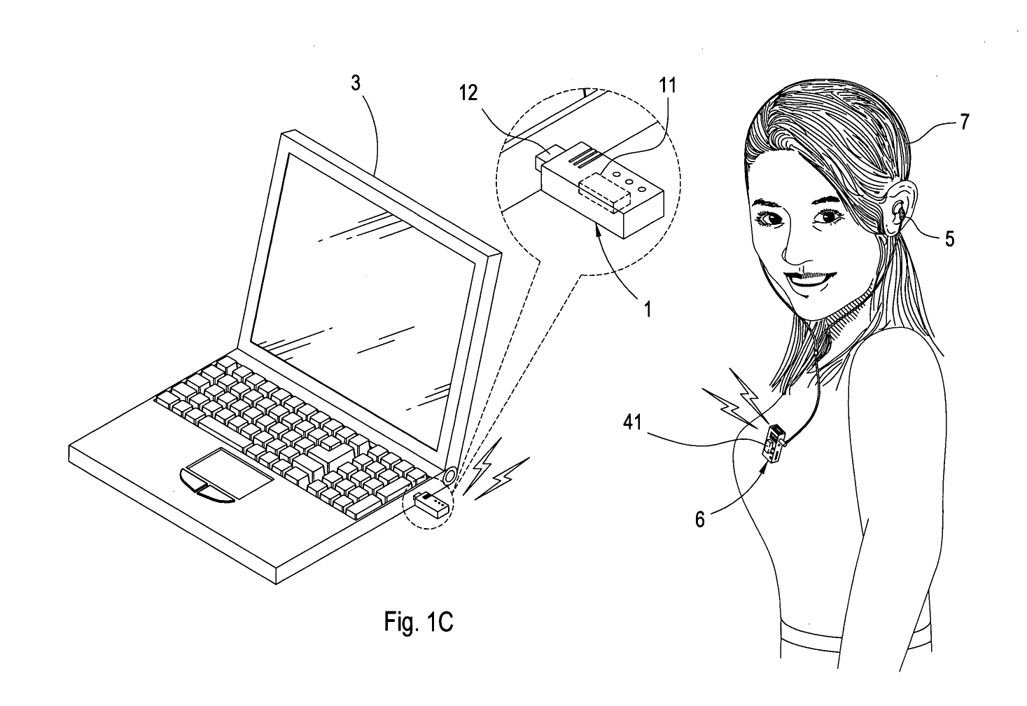

With reference to FIGS. 1A, 1B and 1C, the structure of the multi-sound source wireless transmission system of the present invention is illustrated. The multi-sound source wireless transmission system includes the following elements.

A USB connector 12 capable of being inserted to a notebook computer 3

A transmission module 11 is connected to the USB connector 12. The transmission module 11 serves for wirelessly transmitting sound signals to a receiving module 41 in a head mounted earphone 4, as shown in FIG. 1A, by, for example, RF transmission or blue tooth transmission. The head mounted earphone 4 is hung on a user 7.

The receiving module 41 can be designed for hanging on the waist. The receiving module 41 is connected to an inserting type earphone 5, as shown in FIG. 1B.

Referring to FIG. 1C, in this example, the receiving module 41 is installed to an MP3 player 6 for hanging from the neck of the user 7. The receiving module 41 is connected to an inserting type earphone 5 for listening the sounds from the earphone.

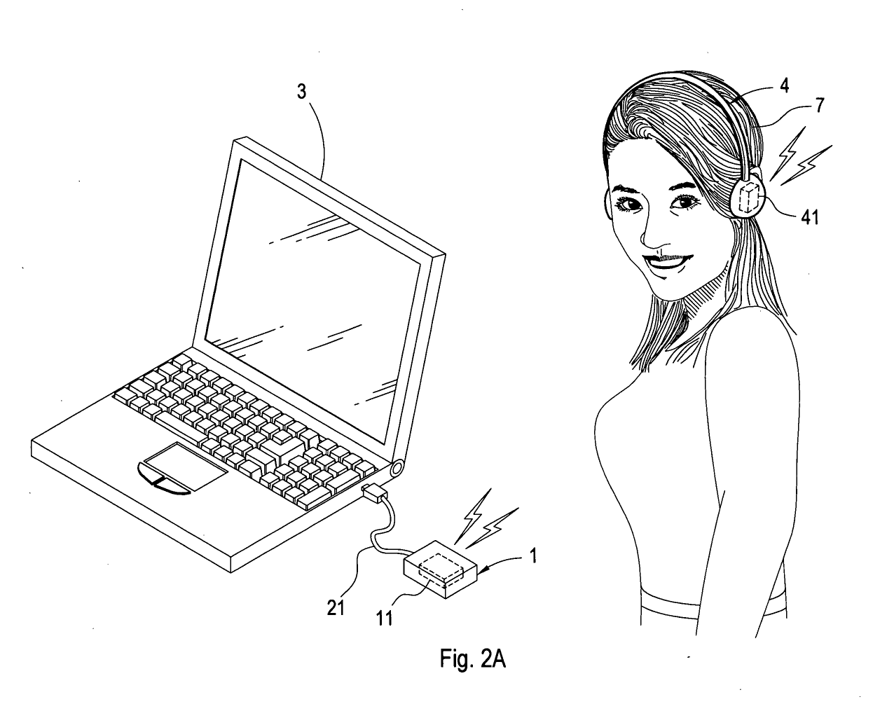

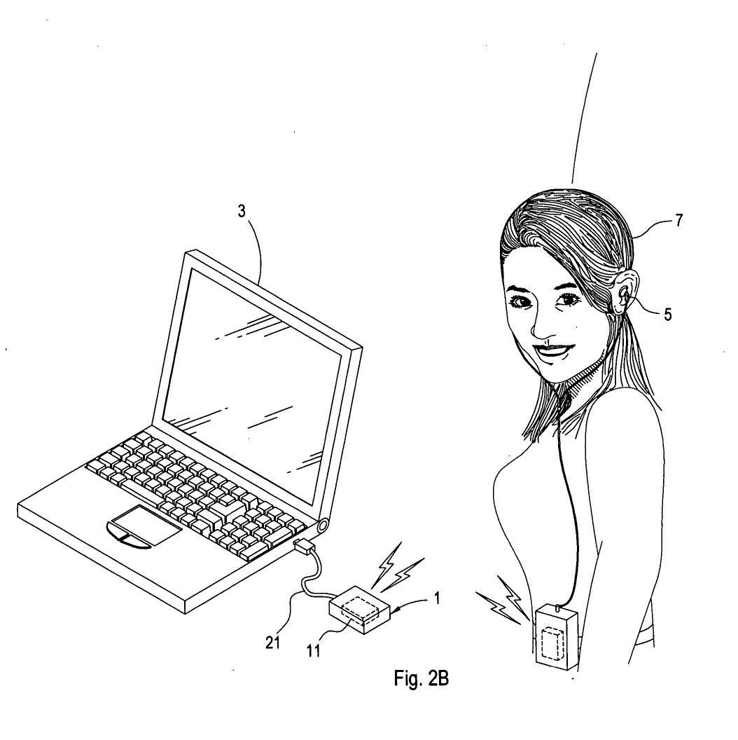

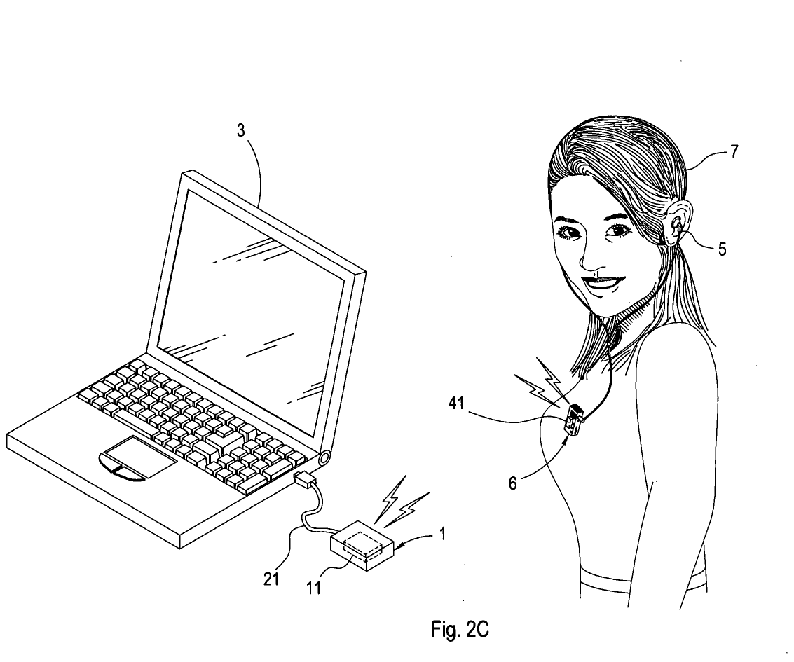

With reference to FIGS. 2A, 2B, and 2C, the second embodiment of the multi-sound source wireless transmission system of the present invention is illustrated. The multi-sound source wireless transmission system has the following elements.

A USB transmission wire 21 serves for transmitting sound signals to a notebook computer 3.

A transmission module 11 is connected to the USB transmission wire 21. The transmission module 11 serves for wirelessly transmitting sound signals to a receiving module 41 in a head mounted earphone 4, as shown in FIG. 2A, by, for example, RF transmission or blue tooth transmission. The head mounted earphone 4 is hung on a user 7.

The receiving module 41 can be designed for hanging on the waist. The receiving module 41 is connected to an inserting type earphone 5, as shown in FIG. 2B.

Referring to FIG. 2C, in this example, the receiving module 41 is installed to an MP3 player 6 for hanging from the neck of the user 7. The receiving module 41 is connected to an inserting type earphone 5 for listening the sounds from the earphone.

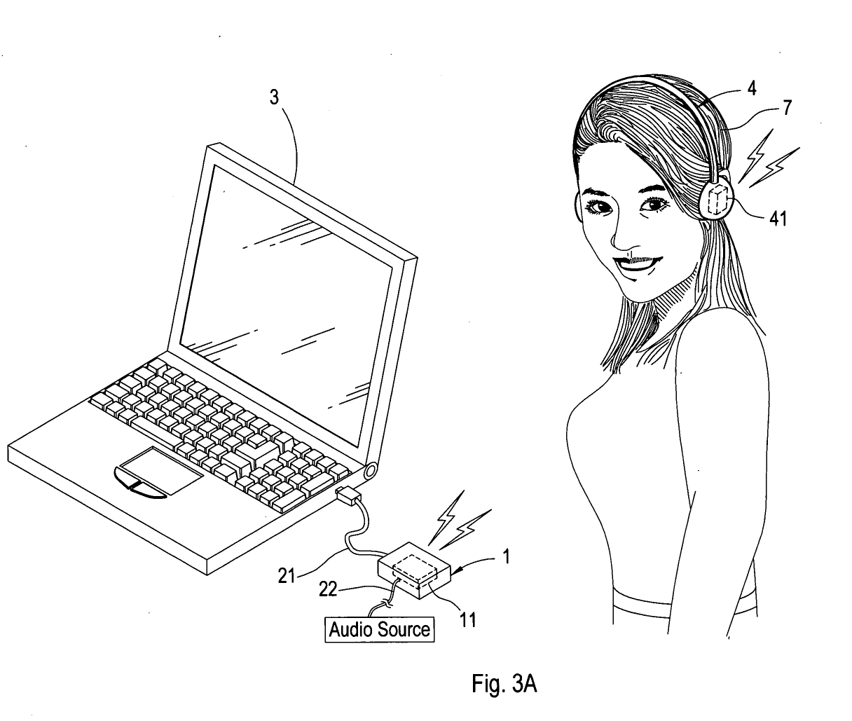

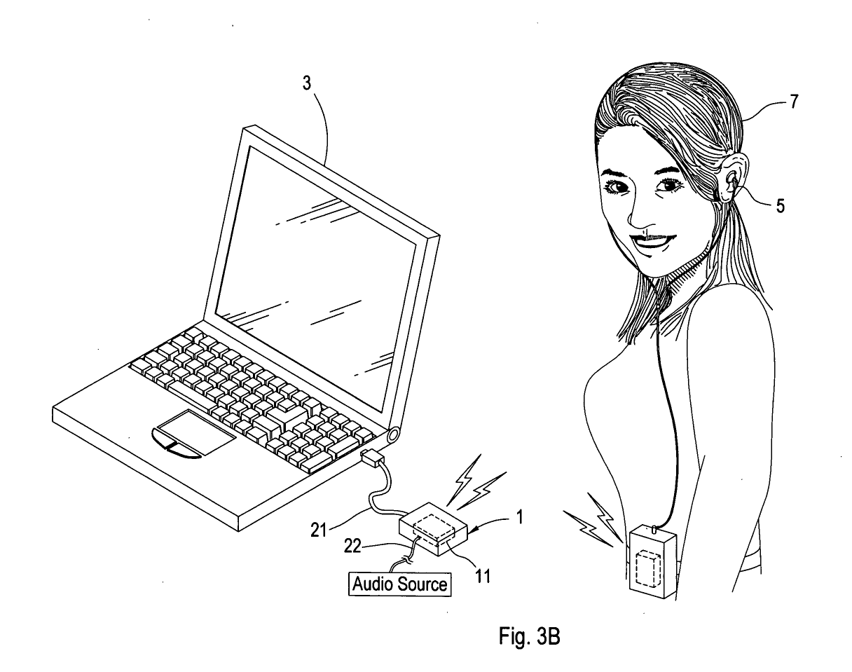

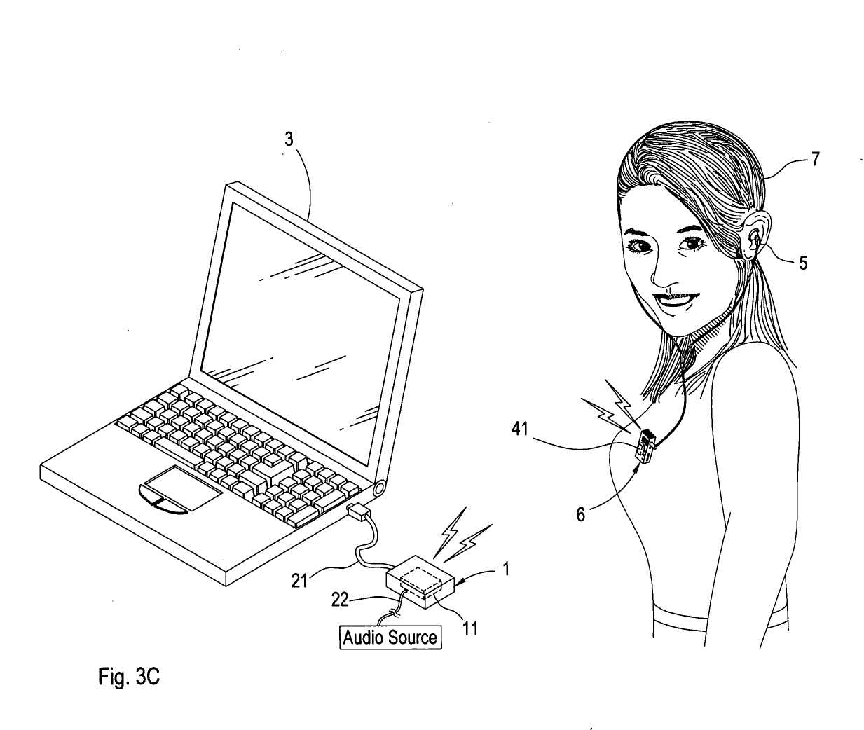

With reference to FIGS. 3A, 3B, and 3C, the third embodiment of the multi-sound source wireless transmission system of the present invention is illustrated. The multi-sound source wireless transmission system has the following elements.

A USB transmission wire 21 serves for transmitting sound signals to a notebook computer 3 or an audio wire 22 for receiving sound signals from CDs, MP3, DVDs, VCDs, stereos, computers, etc.

A transmission module 11 is connected to the USB transmission wire 21. The transmission module 11 serves for wirelessly transmitting sound signals to a receiving module 41 in a head mounted earphone 4, as shown in FIG. 3A, by, for example, RF transmission or blue tooth transmission. The head mounted earphone 4 is hung on a user 7.

The receiving module 41 can be designed for hanging on the waist. The receiving module 41 is connected to an inserting type earphone 5, as shown in FIG. 3B.

Referring to FIG. 3C, in this example, the receiving module 41 is installed to an MP3 player 6 for hanging from the neck of the user 7. The receiving module 41 is connected to an inserting type earphone 5 for listening the sounds from the earphone.

The power of the multi-sound source wireless transmission system 1 of the present invention may be from batteries or other external power source.

Advantages of the present invention will be described herein. Firstly, in the multi-sound source wireless transmission system, the sound signals are wirelessly transmitted to a far end receiving module so that the use can hear the sound with a better quality. Secondary, the transmission of the sound signals in the present invention is performed by RF transmission or blue tooth transmission. In the present invention, the sound source may be CDs, MP 3 players, TVs, Turners, DVDs, VCDs, stereos, and furthermore the present invention can be connected to a table type computer, a notebook computer, or a PDAs, etc. for receiving sound signals. Furthermore, the multi-sound source wireless transmission system of the present invention has lower decay, especially when the signal is transmitted to a far end. Furthermore, the present invention can be assembled quickly and easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multi-sound source wireless transmission system comprising:
a USB transmission line capable of being inserted to one of a notebook computer or an audio signal wire connected to a first electronic device;
a transmission module connected to the USB transmission line for wirelessly transmitting sound signals to a receiving module in a far end second electronic device.

2. The multi-sound source wireless transmission system as claimed in claim 1, wherein the second electronic device is one of a CDs, MP3 players, TVs, Tuners, DVDs, VCDs, stereos, and computers.

3. The multi-sound source wireless transmission system as claimed in claim 1, wherein the receiving module has a head mounted earphone.

4. The multi-sound source wireless transmission system as claimed in claim 1, wherein the wireless transmission is one of RF transmission and blue tooth transmission.

5. The multi-sound source wireless transmission system as claimed in claim 1, wherein the second electronic device is a head mounted earphone.

6. The multi-sound source wireless transmission system as claimed in claim 1, wherein the receiving module is capable of being hung on a waist of a user and is connected to an inserting type earphone

7. The multi-sound source wireless transmission system as claimed in claim 1, wherein the receiving module is installed to an MP3 player so that the transmission module is capable of being hung from the neck of the user; and the receiving module is connected to an inserting type earphone for listening the sounds from the earphone.

8. A multi-sound source wireless transmission system comprising:
a USB connector capable of being inserted to a notebook computer;
a transmission module connected to the USB connector for wirelessly transmitting sound signals to a receiving module in a far end second electronic device.

9. The multi-sound source wireless transmission system as claimed in claim 8, wherein the second electronic device is one of a CDs, MP3 players, TVs, Tuners, DVDs, VCDs, stereos, and computers.

10. The multi-sound source wireless transmission system as claimed in claim 8, wherein the receiving module has a head mounted earphone.

11. The multi-sound source wireless transmission system as claimed in claim 8, wherein the wireless transmission is one of RF transmission and blue tooth transmission.

12. The multi-sound source wireless transmission system as claimed in claim 8, wherein the second electronic device is a head mounted earphone.

13. The multi-sound source wireless transmission system as claimed in claim 8, wherein the receiving module is capable of being hung on the waist of a user and is connected to an inserting type earphone.

14. A multi-sound source wireless transmission system comprising:
a USB transmission line capable of being inserted to a notebook computer;
a transmission module connected to the USB transmission line for wirelessly transmitting sound signals to a receiving module in a far end second electronic device.

15. The multi-sound source wireless transmission system as claimed in claim 14, wherein the second electronic device is one of a CDs, MP3 players, TVs, Tuners, DVDs, VCDs, stereos, and computers.

16. The multi-sound source wireless transmission system as claimed in claim 14, wherein the receiving module has a head mounted earphone.

17. The multi-sound source wireless transmission system as claimed in claim 14, wherein the wireless transmission is one of RF transmission and blue tooth transmission.

18. The multi-sound source wireless transmission system as claimed in claim 14, wherein the second electronic device is a head mounted earphone.

19. The multi-sound source wireless transmission system as claimed in claim 14, wherein the receiving module is capable of being hung on the waist and is connected to an inserting type earphone.

20. The multi-sound source wireless transmission system as claimed in claim 14, wherein the receiving module is installed to an MP3 player so that it can be hung from the neck of the user; and the receiving module is connected to an inserting type earphone for listening the sounds from the earphone.
